(19) United States
(12) Patent Application Publication
(10) Pub. No.: US 2024/0039393 A1
(43) Pub. Date: Feb. 1, 2024

(54) DC-DC POWER CONVERTER FILTERING SYSTEM

(71) Applicant: GM GLOBAL TECHNOLOGY OPERATIONS LLC, Detroit, MI (US)

(72) Inventors: Akshay Sarin, Auburn Hills, MI (US); Alan B. Martin, Washington, MI (US); Joseph Berg, Highland, MI (US)

(73) Assignee: GM GLOBAL TECHNOLOGY OPERATIONS LLC, Detroit, MI (US)

(21) Appl. No.: 17/875,189

(22) Filed: Jul. 27, 2022

(51) Int. Cl. H02M 1/14; H02M 1/00; H02M 3/158

(52) U.S. Cl. CPC H02M 1/143; H02M 1/0009; H02M 1/0043; H02M 3/1586

(57) ABSTRACT

A system for transferring DC electric power to a DC electric power system includes an electric power source, a DC-DC power converter, a system power bus including a capacitor, a first current sensor, a second current sensor, a third current sensor, and a controller. The DC-DC power converter includes a switched inductance circuit including an inductor, a high-voltage switch, and a diode. The second current sensor monitors a second current in the system power bus between the DC-DC power converter and the capacitor. The controller determines a parametric setpoint for the system power bus, determines the first current, the second current, and the third current in the system power bus, and controls the switching DC-DC power converter based upon the parametric setpoint, the first current, the second current, and the third current.

### INTRODUCTION

Electric power systems may employ DC-DC power converters to increase voltage levels of DC electric power that is output from an electric power source, which may be transferred to an electric power system. The electric power system may induce voltage and current ripple, which may be undesirable.

### SUMMARY

The concepts described herein provide a system, apparatus, and/or method for controlling, managing, and reducing voltage and current ripple in an electric power system that may be induced by switching in a DC-DC power converter, utilizing inherent or internal capacitance of the electric power source. The electric power source may be a fuel cell device, a photovoltaic panel, or an ultracapacitor in one embodiment. Alternatively, the electric power source may be a rechargeable energy storage device. The problem of temporary energy storage and filtering requirements of electric power on a high voltage bus may be addressed by using inherent capacitance of the electric power source along with a DC-DC power converter for filtering out high frequency voltage and current content on an output bus.

An aspect of the disclosure may include a system for transferring DC electric power to a DC electric power system that includes an electric power source, a power source bus, a switching DC-DC power converter, a system power bus, and a controller. The switching DC-DC power converter includes a switched inductance circuit including an inductor, and a high-voltage switch in one embodiment. The system power bus is arranged to transfer electric power between the switching DC-DC power converter and the DC electric power system. The controller is operative to determine an anti-phase ripple current for the power source bus, and control the switching DC-DC power converter to inject the anti-phase ripple current into the system power bus, wherein the anti-phase ripple current is sourced from the electric power source.

Another aspect of the disclosure may include the controller being operative to control the switching DC-DC power converter in an open loop operation to inject the anti-phase ripple current into the system power bus.

Another aspect of the disclosure may include the controller being operative to control the switching DC-DC power converter in a closed loop operation to inject the anti-phase ripple current into the system power bus.

Another aspect of the disclosure may include the controller being operative to control the switching DC-DC power converter employing feedback control to inject the anti-phase ripple current into the system power bus.

Another aspect of the disclosure may include the controller being operative to control the switching DC-DC power converter employing feedback control and feed-forward control to inject the anti-phase ripple current into the system power bus.

Another aspect of the disclosure may include a system for transferring DC electric power to a DC electric power system. The system includes an electric power source, a source power bus, a switching DC-DC power converter, a system power bus including a capacitor, a first current sensor, a second current sensor, a third current sensor, and a controller. The switching DC-DC power converter includes a switched inductance circuit including an inductor, a high-voltage switch, and a diode. The first current sensor is arranged to monitor a first current in the source power bus between the electric power source and the switching DC-DC power converter. The second current sensor is arranged to monitor a second current in the system power bus between the switching DC-DC power converter and the capacitor. The third current sensor is arranged to monitor a third current in the system power bus between the capacitor and the DC electric power system. The controller is operative to determine a parametric setpoint for the system power bus, determine the first current, the second current, and the third current in the system power bus, and control the switching DC-DC power converter based upon the parametric setpoint, the first current, the second current, and the third current.

Another aspect of the disclosure may include the capacitor being electrically connected between a positive link of the system power bus and a negative link of the system power bus.

Another aspect of the disclosure may include the electric power source being a non-rechargeable electric power source.

Another aspect of the disclosure may include the non-rechargeable electric power source being one of a fuel cell stack or a photovoltaic panel.

Another aspect of the disclosure may include the electric power source being one of an ultracapacitor or an electrochemical battery.

Another aspect of the disclosure may include the switching DC-DC power converter being a multi-phase interleaved switching DC-DC power converter including a plurality of switched inductance circuits arranged in parallel, wherein each of the plurality of switched inductance circuits includes an inductor, a high-voltage switch, and a diode; and wherein the controller is operative to control the high-voltage switch of each of the plurality of switched inductance circuits based upon the parametric setpoint, the first current, the second current, and the third current.

Another aspect of the disclosure may include a feedback control system including a plurality of frequency range-specific band-pass filters, wherein the controller is operative to determine a difference between the third current and the second current, subject the difference between the third current and the second current to the plurality of frequency range-specific band-pass filters of the feedback control system to determine a plurality of control parameters, and control the plurality of switched inductance circuits of the switching DC-DC power converter based upon the parametric setpoint, the first current, and the plurality of control parameters.

Another aspect of the disclosure may include a system for transferring electric power between an electric power source and a DC electrical system that includes a switching DC-DC power converter, a system power bus including a capacitive device, and a controller, wherein the controller is operative to determine a parametric setpoint for the system power bus, determine a first current in a source power bus between the electric power source and the switching DC-DC power converter, determine a second current in the system power bus between the switching DC-DC power converter and the capacitive device, determine a third current in the system power bus between the capacitive device and the DC electrical system, determine a difference between the third current and the second current, and control the switching DC-DC power converter based upon the parametric setpoint, the first current, and the difference between the third current and the second current.

Another aspect of the disclosure may include system for transferring DC electric power to an electrical system that includes a DC electric power source, a switching DC-DC power converter, an electric power bus including a capacitor, an active filter, and a controller. The electric power bus electrically connects to the electrical system at an interface. The controller is operative to determine a parametric setpoint for the electric power bus, determine a first current in the electric power bus between the electric power source and the switching DC-DC power converter, determine a second current in the electric power bus between the switching DC-DC power converter and the capacitor, determine a third current in the electric power bus between the capacitor and the electrical system wherein the third current in the electric power bus is determined at the interface to the electrical system. A difference between the third current and the second current is determined and subjected to active filtering, with the resultant being employed to control the switching DC-DC power converter based upon the parametric setpoint, the first current, and the actively filtered difference between the third current and the second current.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawing, in which:

FIG. 1A schematically illustrates an embodiment of an electric power transfer system that includes a DC electric power source, a switching DC-DC power converter, and a controller that electrically connect to an electrical system, in accordance with the disclosure.

FIGS. 1B and 1C graphically illustrate current and voltage, respectively, associated with operation of an embodiment of an electric power transfer system, in accordance with the disclosure.

FIG. 2 schematically illustrates another embodiment of a DC electric power source, a switching DC-DC power converter, an electric power bus including a capacitor, and a controller that electrically connect to an electrical system, in accordance with the disclosure.

FIG. 3 schematically illustrates another embodiment of a DC electric power source, a switching DC-DC power converter, an electric power bus including a capacitor, and a controller that electrically connect to an electrical system, in accordance with the disclosure.

FIG. 4 schematically illustrates another embodiment of a DC electric power source, a switching DC-DC power converter, an electric power bus including a capacitor, and a controller that electrically connect to an electrical system, in accordance with the disclosure.

FIG. 5 schematically illustrates another embodiment of a DC electric power source, a switching DC-DC power converter, an electric power bus including a capacitor, and a controller that electrically connect to an electrical system, in accordance with the disclosure.

The appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail to avoid unnecessarily obscuring the disclosure. Furthermore, the disclosure, as illustrated and described herein, may be practiced in the absence of an element that is not specifically disclosed herein.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

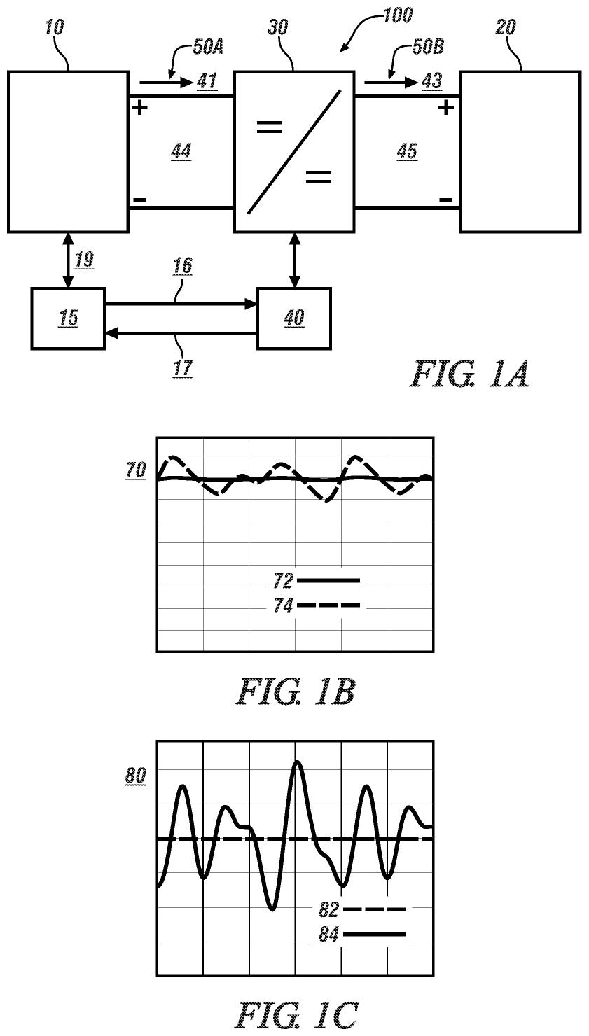

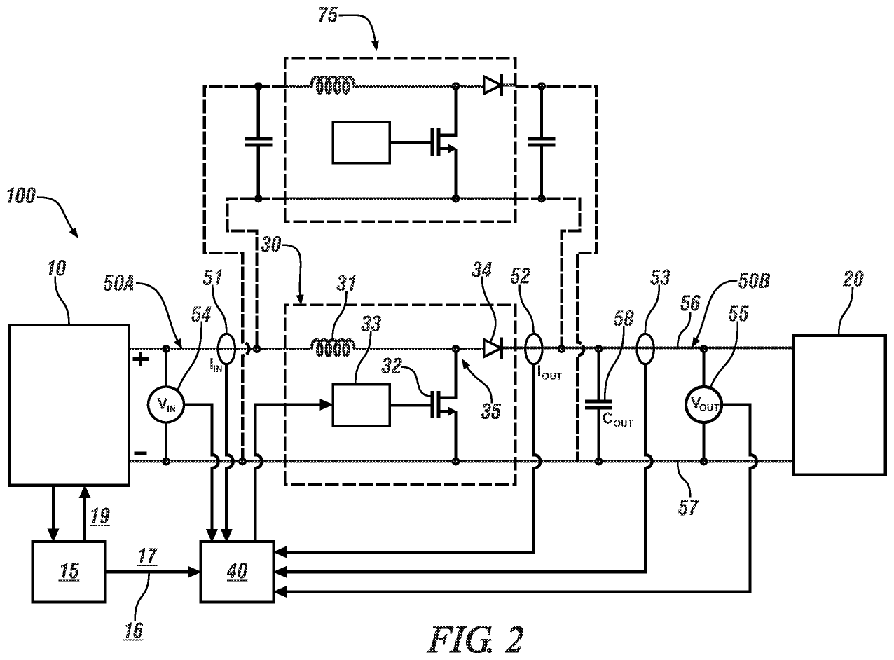

FIGS. 1A and 2, consistent with embodiments disclosed herein, schematically illustrate an electric power transfer system 100 for transferring DC electric power between a DC electric power source 10 and a DC electric power system 20. The electric power transfer system 100 includes a switching DC-DC power converter 30, a power source bus 50A, a system power bus 50B, a system controller 15, and a DC-DC power converter controller 40. In one embodiment, the electric power transfer system 100 is arranged on an electrified vehicle, wherein the DC electric power system 20 provides DC electric power at a preset voltage for use by one or multiple rotary electric machines to generate torque that is transferred to one or more vehicle wheels or propulsion devices for tractive effort.

In one embodiment, the DC electric power source 10 is a fuel cell stack, which provides electrical power to an electrical power system 20 through a switching DC-DC power converter 30. The switching DC-DC power converter 30 may be either a step-up power converter or a step-down power converter that connects the DC electric power source 10 to the electrical power system 20 by changing the voltage and current from the DC electric power source 10 to a preset voltage level to make it electrically compatible to the electrical power system 20.

The DC electric power source 10 transfers electric power, in the form of current 41 and voltage 44, to the switching DC-DC power converter 30 via power source bus 50A. system controller 15 controls and monitors the DC electric power source 10. The switching DC-DC power converter 30 converts the electric power from the DC electric power source 10 and transfers electric power, in the form of current 43 and the preset voltage 45, to the electrical power system 20. The switching DC-DC power converter 30 has added functionality of active power filtering in one embodiment. The electrical power system 20 may include one or a plurality of the switching DC-DC power converters, which may induce significant voltage ripple on the system power bus 50B. As described herein, the switching DC-DC power converter 30 is controlled to cancel voltage and current ripple by drawing an AC current from the DC electric power source 10 and injecting an anti-phase ripple current in the system. The fuel cell stack 10 is largely immune to the high-frequency ripple current due to its inherent capacitance.

The voltage ripple may be determined, in one embodiment, using a system model of the switching DC-DC power converter 30. The voltage ripple may be determined, in one embodiment, using feedback from a current sensor of the switching DC-DC power converter 30.

System controller 15 determines a parametric setpoint 16 for the DC-DC power converter controller 40, wherein the parametric setpoint 16 is composed of a current setpoint that includes an anti-phase ripple current, a voltage setpoint for the electric power system 20, i.e., a step-up voltage or a step-down voltage, a power setpoint, or a combination thereof. The DC-DC power converter controller 40 provides feedback 17 to the system controller 15. The system controller 15 generates the parametric setpoint 16 for the DC-DC power converter controller 40.

The DC-DC power converter controller 40 controls the switching DC-DC power converter 30 to draw the desired current from the DC electric power source 10.

The parametric setpoint 16 is dynamically set to achieve current ripple cancellation via the switching DC-DC power converter 30 such that the electric power in the system power bus 50B is at the preset voltage with minimal voltage ripple and/or current ripple, thus reducing the need for and/or the size of noise cancellation filters in the electric power system 20.

Referring to FIG. 2, in one embodiment, the switching DC-DC power converter 30 may be arranged in parallel with a second DC-DC power converter 75 between the DC electric power source 10 and the DC electric power system 20. In this embodiment, the second DC-DC power converter 75 may be designed, configured and controlled to transfer power based upon a voltage setpoint for the DC electric power system 20. In this embodiment, the switching DC-DC power converter 30 may be controlled to inject the anti-phase ripple current into the DC electric power system 20 by drawing an AC current from the DC electric power source 10.

FIG. 1B graphically illustrates voltage 70 on the vertical axis in relation to time on the horizontal axis, with a first line 74 illustrating voltage on the system power bus 50B without an embodiment of the electric power transfer system 100 described with reference to FIG. 1A. A second line 72 illustrates voltage on the system power bus 50B using an embodiment of the electric power transfer system 100 described with reference to FIG. 1A, thus demonstrating an improvement in the voltage on the system power bus 50B as a result of operation of the electric power transfer system 100.

FIG. 1C graphically illustrates current 80 on the vertical axis in relation to time on the horizontal axis, with a first line 84 illustrating current on the system power bus 50B without an embodiment of the electric power transfer system 100 described with reference to FIG. 1A. A second line 82 illustrates current on the system power bus 50B with an embodiment of the electric power transfer system 100 described with reference to FIG. 1A, thus demonstrating an improvement in the current on the system power bus 50B as a result of operation of the electric power transfer system 100. It can be accomplished by injecting an anti-phase ripple current from the switching DC-DC power converter to reduce the ripple on the system voltage.

The ripple cancellation is achieved by actively controlling the switching DC-DC power converter 30, and may be achieved in several ways. The ripple cancellation may be achieved employing open loop control of the switching DC-DC power converter 30 with system ripple information, as illustrated with reference to FIG. 1A, or employing closed-loop control of the switching DC-DC power converter 30, as illustrated with reference to FIGS. 2, 3, 4, and 5. The ripple cancellation may be achieved employing open loop control of the switching DC-DC power converter 30 while incorporating system operating parameters. The ripple cancellation may be achieved employing feed-forward control of the switching DC-DC power converter 30. The ripple cancellation may be achieved employing feedback control, including feed-forward control of the switching DC-DC power converter 30 with active filtering. The ripple cancellation may be achieved employing a combination of feed-forward control, feedback control, and/or incorporating system operating parameters. Configurations associated with these embodiments are described with reference to the Figures herein.

Referring again to FIG. 2, consistent with embodiments disclosed herein, an embodiment of an electric power transfer system 100 for transferring DC electric power between a DC electric power source 10 and a DC electric power system 20 is schematically illustrated. The electric power transfer system 100 includes a switching DC-DC power converter 30, a system power bus 50B including a capacitor 58, a system controller 15, and a DC-DC power converter controller 40. In one embodiment, the electric power transfer system 100 is arranged on an electrified vehicle, wherein the DC electric power system 20 provides DC electric power for use by one or multiple rotary electric machines to generate torque that is transferred to one or more vehicle wheels or propulsion devices for tractive effort. The electrified vehicle may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure. In addition, the concepts described herein may be applied to a system in which an embodiment of the electric power transfer system 100 is arranged to supply electrical power to one or more stationary electric machines, such as a generator.

The concepts described herein filter and otherwise mitigate effects of voltage and/or current ripple that may result from operation of switching in the switching DC-DC power converter 30 of the electric power system 20, relying upon internal or inherent capacitance of the DC electric power source 10.

The electric power source 10 is a controllable electric power generating device that is capable of controlling electric power, i.e., controlling current and/or voltage that is being transferred to the electric power system 20 via the power source bus 50A, the switching DC-DC power converter 30, and the system power bus 50B. The electric power source further has an internal capacitance, in one embodiment. In one embodiment, the electric power source 10 is a non-rechargeable electric power source, meaning that it cannot be electrically recharged by an electrical charging unit. In one embodiment, the electric power source 10 is a fuel cell stack. In one embodiment, the electric power source 10 is a photovoltaic panel. In one embodiment, the electric power source 10 is an ultracapacitor. Alternatively, the electric power source 10 may be an electrochemical battery.

The electric power transfer system 100 includes the switching DC-DC power converter 30, power source bus 50A, system power bus 50B including a temporary energy storage element such as a capacitor 58, system controller 15, and DC-DC power converter controller 40. It is appreciated that operations of the system controller 15 and the DC-DC power converter controller 40 may be implemented by a single controller. The system power bus 50B includes a positive bus (HV1+) 56 and a negative bus (HV1−) 57.

The switching DC-DC power converter 30 of this embodiment includes a single switched inductance circuit 35 that includes an inductor 31, a high-voltage switch 32, a diode 34, and a gate driver 33. The gate driver 33 controls activation and deactivation of the high-voltage switch 32 to control operation of the switching DC-DC power converter 30. In one embodiment, the diode 34 may be replaced by a high-voltage switching device.

The inductor 31 and diode 34 are arranged in series on HV+ 56.

The high-voltage switch 32 is arranged between HV+ 56 and HV− 57 and between the inductor 31 and diode 34, and may include a semiconductor device such as a metal oxide semiconductor field-effect transistor (MOSFET), an integrated gate bipolar transistor (IGBT), or another solid state electronic switching device, and is controllable by the gate driver 33 in a conducting mode (ON) and a blocking mode (OFF) in response to a control signal that originates from the DC-DC power converter controller 40. The capacitor 58 is arranged between HV+ 56 and HV− 57.

The electric power transfer system 100 includes a plurality of sensors that dynamically monitor and communicate parameters thereof. This includes a first voltage sensor 54 that is arranged to monitor electrical potential on the system power bus 50B between HV+ 56 and HV− 57 between the electric power source 10 and the switching DC-DC power converter 30. This further includes a second voltage sensor 55 that is arranged to monitor electrical potential on the system power bus 50B between HV+ 56 and HV− 57 between the switching DC-DC power converter 30 and the DC electric power system 20.

This further includes a first current sensor 51, a second current sensor 52, and a third current sensor 53, thus providing feedback control in a closed-loop operation.

The first current sensor 51 is arranged to monitor a first current in the power source bus 50A between the electric power source 10 and the switching DC-DC power converter 30.

The second current sensor 52 is arranged to monitor a second current in the HV+ 56 of the system power bus 50B between the switching DC-DC power converter and the capacitor 58. The second current sensor 52 monitors and detects, in high fidelity, a power ripple in the output power on HV+ 56 of the system power bus 50B upstream of the capacitor 58.

The third current sensor 53 is arranged to monitor a third current in HV+ 56 of the system power bus 50B between the capacitor 58 and the DC electric power system 20.

One or more of the first current sensor 51, the second current sensor 52, and the third current sensor 53 is a high bandwidth current sensor that is capable of precise, accurate measurement of current and current variations that are caused by operations of the single switched inductance circuit 35.

The DC-DC power converter controller 40 includes algorithmic code, calibrations, etc. to monitor the parametric setpoint 16 for the system power bus 50B, the first current using input from the first current sensor 51, the second current using input from the second current sensor 52, the third current using input from the third current sensor 53, the first voltage potential using input from the first voltage sensor 54, and the second voltage potential using input from the second voltage sensor 55.

The DC-DC power converter controller 40 controls the high-voltage switch 32 of the switching DC-DC power converter 30 based upon the parametric setpoint 16, the first current, the second current, and the third current. This includes, in one embodiment, controlling the high-voltage switch 32 of the switching DC-DC power converter 30 based upon the parametric setpoint 16, the first current, and a difference between the second current and the third current, i.e., a feedback control loop.

The system controller 15 is arranged to monitor operating parameters of the electric power source 10, and determine the parametric setpoint 16 for the system power bus 50B based thereon. The parametric setpoint 16 may include a voltage potential, a current level, an electric power level, or another electric parameter. The system controller 15 controls electric power output of the electric power source 10 in response to the parametric setpoint 16.

The system controller 15 acts to control the electric power output of the electric power source 10 in response to the parametric setpoint 16 in concert with the DC-DC power converter controller 40 controlling the high-voltage switch 32 of the switching DC-DC power converter 30 based upon the parametric setpoint 16, the first current, and a difference between the second current and the third current. This control action transfers the power ripple in the output power on HV+ 56 of the system power bus 50B that occurs upstream of the capacitor 58 and is caused by the operation of the switching DC-DC power converter 30 to the electric power source 10.

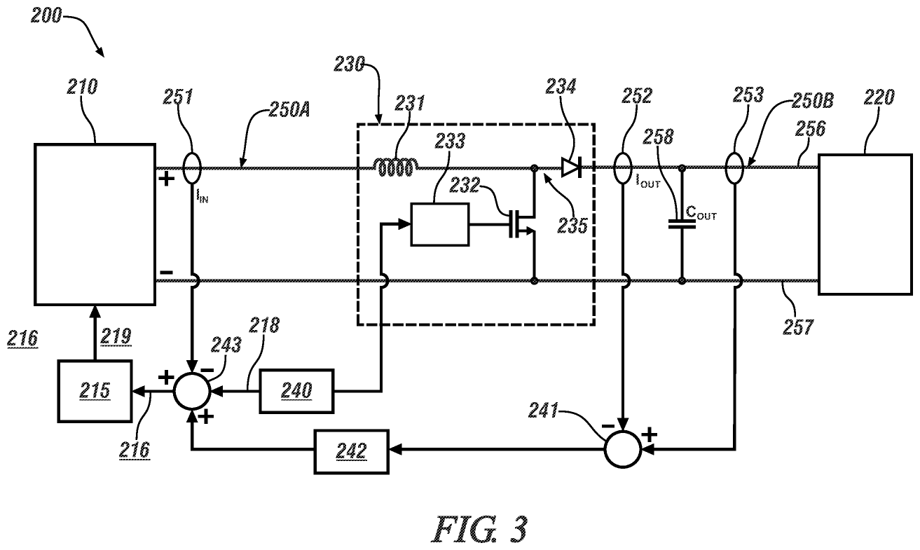

FIG. 3, consistent with embodiments disclosed herein, schematically illustrates another embodiment of an electric power transfer system 200 for transferring DC electric power between a DC electric power source 210 and a DC electric power system 220. The electric power transfer system 200 includes a switching DC-DC power converter 230, an electric power bus 250 including a capacitor 258, a system controller 215, and a DC-DC power converter controller 240.

The concepts described herein filter and otherwise mitigate effects of voltage and/or current ripple that may result from operation of the switching DC-DC power converter 230, relying upon internal or inherent capacitance of the DC electric power source 210.

The electric power source 210 is a controllable electric power generating device that is capable of controlling electric power, i.e., controlling current and/or voltage that is being transferred to the power source bus 250A. The electric power source 210 further has an internal capacitance, in one embodiment. In one embodiment, the electric power source 210 is a non-rechargeable electric power source, meaning that it cannot be electrically recharged by an electrical charging unit. In one embodiment, the electric power source 210 is a fuel cell stack. In one embodiment, the electric power source 210 is a photovoltaic panel. In one embodiment, the electric power source 210 is an ultracapacitor. Alternatively, the electric power source 210 may be an electrochemical battery.

The electric power transfer system 200 includes a switching DC-DC power converter 230, system power bus 250B including capacitor 258, system controller 215, and DC-DC power converter controller 240. It is appreciated that operations of the system controller 215 and the DC-DC power converter controller 240 may be implemented by a single controller. The system power bus 250B includes a positive bus (HV1+) 256 and a negative bus (HV1−) 257.

The switching DC-DC power converter 230 of this embodiment includes a single switched inductance circuit 235 that includes an inductor 231, a high-voltage switch 232, a diode 234, and a gate driver 233. The gate driver 233 controls activation and deactivation of the high-voltage switch 232 to control operation of the switching DC-DC power converter 230.

The inductor 231 and diode 234 are arranged in series on HV+ 256.

The high-voltage switch 232 is arranged between HV+ 256 and HV− 257 and between the inductor 231 and diode 234, and may include a semiconductor device such as a metal oxide semiconductor field-effect transistor (MOSFET), an integrated gate bipolar transistor (IGBT), or another solid state electronic switching device, and is controllable by the gate driver 233 in a conducting mode (ON) and a blocking mode (OFF) in response to a control signal that originates from the DC-DC power converter controller 240. The capacitor 258 is arranged between HV+ 256 and HV− 257. The electric power transfer system 200 includes a plurality of sensors that dynamically monitor and communicate parameters thereof, thus providing feedback control in a closed-loop operation. This includes a first current sensor 251, a second current sensor 252, and a third current sensor 253.

The first current sensor 251 is arranged to monitor a first current in HV+ 256 of the power source bus 250A between the electric power source 210 and the switching DC-DC power converter 230.

The second current sensor 252 is arranged to monitor a second current in the HV+ 256 of the system power bus 250B between the switching DC-DC power converter 230 and the capacitor 258. The second current sensor 252 monitors and detects, in high fidelity, a power ripple in the output power on HV+ 256 of the system power bus 250B upstream of the capacitor 258.

The third current sensor 253 is arranged to monitor a third current in HV+ 256 of the system power bus 250B between the capacitor 258 and the DC electric power system 220.

One or more of the first current sensor 251, the second current sensor 252, and the third current sensor 253 is a high bandwidth current sensor that is capable of precise, accurate measurement of current and current variations that are caused by operations of the single switched inductance circuit 235.

The DC-DC power converter controller 240 includes algorithmic code, calibrations, etc., to monitor the parametric setpoint 216 for the system power bus 250B, the first current using input from the first current sensor 251, the second current using input from the second current sensor 252, and the third current using input from the third current sensor 253.

A first difference element 241 dynamically determines an arithmetic difference between the third current and the second current, and the arithmetic difference between the third current and the second current is subjected to active filtering in the form of high bandwidth compensation 242.

A second difference element 243 arithmetically adds the parametric setpoint 216 and the arithmetic difference between the third current and the second current subjected to the high bandwidth compensation, and subtracts the first current, with the resultant 218 being provided as input to the DC-DC power converter controller 240.

The DC-DC power converter controller 240 controls the high-voltage switch 232 of the switching DC-DC power converter 230 based thereon.

The system controller 215 is arranged to monitor operating parameters of the electric power source 210, and determine the parametric setpoint 216 for the system power bus 250B based thereon. The parametric setpoint 216 may include a voltage potential, a current level, an electric power level, or another electric parameter. The system controller 215 controls electric power output of the electric power source 210 in response to the parametric setpoint 216.

The system controller 215 acts to control the electric power output of the electric power source 210 in response to the parametric setpoint 216 in concert with the DC-DC power converter controller 240 controlling the high-voltage switch 232 of the switching DC-DC power converter 230 based upon the parametric setpoint 216, the first current, and a difference between the second current and the third current. This control action transfers the power ripple in the output power on HV+ 256 of the system power bus 250B that occurs upstream of the capacitor 258 and is caused by the operation of the switching DC-DC power converter 230 to the electric power source 210.

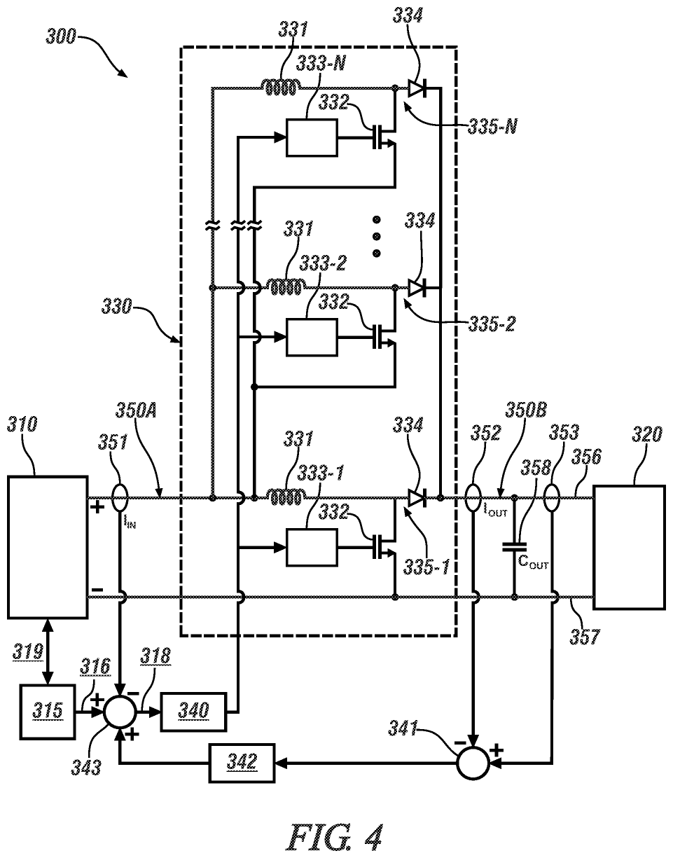

FIG. 4, consistent with embodiments disclosed herein, schematically illustrates an embodiment of an electric power transfer system 300 for transferring DC electric power between a DC electric power source 310 and a DC electric power system 320. The electric power transfer system 300 includes a switching DC-DC power converter 330, an electric power bus 350 including a capacitor 358, a system controller 315, and a DC-DC power converter controller 340.

The concepts described herein filter and otherwise mitigate effects of voltage and/or current ripple that may result from operation of the switching DC-DC power converter 330, relying upon internal or inherent capacitance of the DC electric power source 310.

The electric power source 310 is a controllable electric power generating device that is capable of controlling electric power, i.e., controlling current and/or voltage that is being transferred to the power source bus 350A. The electric power source further has an internal capacitance, in one embodiment. In one embodiment, the electric power source 310 is a non-rechargeable electric power source, meaning that it cannot be electrically recharged by an electrical charging unit. In one embodiment, the electric power source 310 is a fuel cell stack. In one embodiment, the electric power source 310 is a photovoltaic panel. In one embodiment, the electric power source 310 is an ultracapacitor. Alternatively, the electric power source 310 may be an electrochemical battery.

The electric power transfer system 300 includes a switching DC-DC power converter 330, a system power bus 350B including capacitor 358, system controller 315, and DC-DC power converter controller 340. It is appreciated that operations of the system controller 315 and the DC-DC power converter controller 340 may be implemented by a single controller. The system power bus 350B includes a positive bus (HV1+) 356 and a negative bus (HV1−) 357.

In one embodiment, the switching DC-DC power converter 330 includes a plurality of interleaved switched inductance circuits 335-1, 335-2, . . . , 335-n, and software drivers and corresponding controller hardware that are disposed in a gate driver circuit composed of a corresponding plurality of gate drivers 333-1, 333-2, . . . , 333-n, wherein “n” is a numeric value that indicates a quantity of the switched inductance circuits and gate drivers. The DC-DC power converter controller 340 is operationally connected to the plurality of gate drivers 333-1, 333-2, . . . , 333-n. Each of plurality of interleaved switched inductance circuits 335-1, 335-2, . . . , 335-n includes an inductor 331, a diode 334 and a power switch 332, including one of the inductors 331 being electrically connected to a node that electrically connects one of the diodes 334 and one of the power switches 333. The respective inductor 331 is arranged between HV1+ 356 and the node, and the respective diode 334 is arranged in series with the respective power switch 332 between HV1+ 356 and HV1− 357. One of the inductors 331 is arranged between HV1+ 336 and the junction of the respective diode 334 in series with the respective power switch 332. Design aspects of the aforementioned are application-specific, and depend upon factors such as power demand, current flow, operating environment, etc.

The inductor 331 and diode 334 are arranged in series on HV+ 356.

Each of high-voltage switches 332 is arranged between HV+ 356 and HV− 357 and between the inductor 331 and diode 334, and may include a semiconductor device such as a metal oxide semiconductor field-effect transistor (MOSFET), an integrated gate bipolar transistor (IGBT), or another solid state electronic switching device, and is controllable by the respective one of the gate drivers 333-1, 333-2, . . . , 333-n in a conducting mode (ON) and a blocking mode (OFF) in response to a control signal that originates from the DC-DC power converter controller 340. The capacitor 358 is arranged between HV+ 356 and HV− 357.

The electric power transfer system 300 includes a plurality of sensors that dynamically monitor and communicate parameters thereof, thus providing feedback control operation in a closed-loop operation.

This includes a first current sensor 351, a second current sensor 352, and a third current sensor 353.

The first current sensor 351 is arranged to monitor a first current in HV+ 356 of the system power bus 350B between the electric power source 310 and the switching DC-DC power converter 330.

The second current sensor 352 is arranged to monitor a second current in the HV+ 356 of the system power bus 350B between the switching DC-DC power converter 330 and the capacitor 358. The second current sensor 352 monitors and detects, in high fidelity, a power ripple in the output power on HV+ 356 of the system power bus 350B upstream of the capacitor 358.

The third current sensor 353 is arranged to monitor a third current in HV+ 356 of the system power bus 350B between the capacitor 358 and the DC electric power system 320.

One or more of the first current sensor 351, the second current sensor 352, and the third current sensor 353 is a high bandwidth current sensor that is capable of precise, accurate measurement of current and current variations that are caused by operations of the switched inductance circuit 335.

The DC-DC power converter controller 340 includes algorithmic code, calibrations, etc., to monitor the parametric setpoint 316 for the system power bus 350B, the first current using input from the first current sensor 351, the second current using input from the second current sensor 352, and the third current using input from the third current sensor 353.

A first difference element 341 dynamically determines an arithmetic difference between the third current and the second current, and the arithmetic difference between the third current and the second current is subjected to active filtering in the form of a high bandwidth compensation 342.

A second difference element 343 arithmetically adds the parametric setpoint 316 and the arithmetic difference between the third current and the second current subjected to the high bandwidth compensation, and subtracts the first current, with the resultant 318 being provided as input to the DC-DC power converter controller 340.

The DC-DC power converter controller 340 controls the plurality of high-voltage switches 332 of the switching DC-DC power converter 330 via the plurality of gate drivers 333-1, 333-2, . . . , 333-n based thereon.

The system controller 315 is arranged to monitor operating parameters of the electric power source 310, and determine a parametric setpoint 316 for the power source bus 350A based thereon. The parametric setpoint 316 may include a voltage potential, a current level, an electric power level, or another electric parameter. The system controller 315 controls electric power output of the electric power source 310 in response to the parametric setpoint 316.

The system controller 315 acts to control the electric power output of the electric power source 310 in response to the parametric setpoint 316 in concert with the DC-DC power converter controller 340 controlling the high-voltage switch 332 of the switching DC-DC power converter 330 based upon the parametric setpoint 316, the first current, and a difference between the second current and the third current. This control action transfers the power ripple in the output power on HV+ 356 of the system power bus 350B that occurs upstream of the capacitor 358 and is caused by the operation of the switching DC-DC power converter 330 to the electric power source 310.

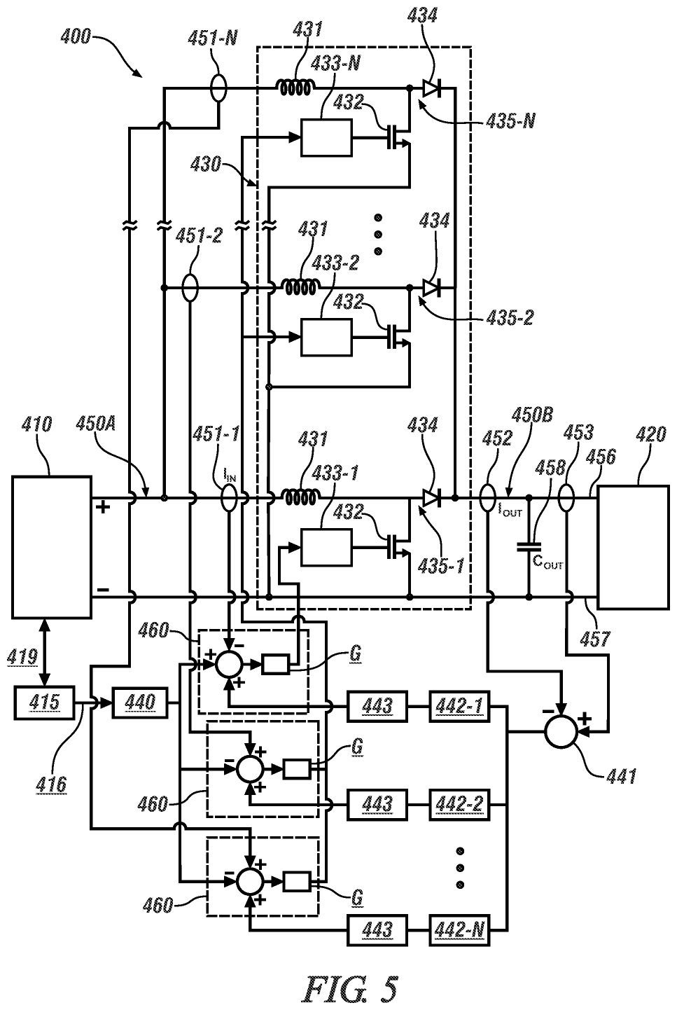

FIG. 5, consistent with embodiments disclosed herein, schematically illustrates another embodiment of an electric power transfer system 400 for transferring DC electric power between a DC electric power source 410 and a DC electric power system 420. The electric power transfer system 400 includes a multi-phase interleaved switching DC-DC power converter 430, a power source bus 450A, system power bus 450B including a capacitor 458, a system controller 415, and a DC-DC power converter controller 440. The system power bus 450B includes a positive bus (HV1+) 456 and a negative bus (HV1−) 457.

The electric power source 410 is a controllable electric power generating device that is capable of controlling electric power, i.e., controlling current and/or voltage that is being transferred to the power source bus 450A. The electric power source further has an internal capacitance, in one embodiment. In one embodiment, the electric power source 410 is a non-rechargeable electric power source, meaning that it cannot be electrically recharged by an electrical charging unit. In one embodiment, the electric power source 410 is a fuel cell stack. In one embodiment, the electric power source 410 is a photovoltaic panel. In one embodiment, the electric power source 410 is an ultracapacitor. Alternatively, the electric power source 410 may be an electrochemical battery.

In one embodiment, the multi-phase interleaved switching DC-DC power converter 430 includes a plurality of interleaved switched inductance circuits 435-1, 435-2, . . . , 435-n, and software drivers and corresponding controller hardware that are disposed in a gate driver circuit composed of a corresponding plurality of gate drivers 433-1, 433-2, . . . , 433-n, wherein “n” is a numeric value that indicates a quantity of the switched inductance circuits and gate drivers. The DC-DC power converter controller 440 is operationally connected to the plurality of gate drivers 433-1, 433-2, . . . , 433-n. Each of plurality of interleaved switched inductance circuits 435-1, 435-2, . . . , 435-n includes an inductor 431, a diode 434 and a power switch 432, including one of the inductors 431 being electrically connected to a node that electrically connects one of the diodes 434 and one of the power switches 433. The respective inductor 431 and diode 434 are arranged in series on HV+ 456. The respective power switch 432 is arranged between HV1+ 456 and HV1− 457. A plurality of first current sensors 451-1, 451-2, . . . , 451-n are arranged to monitor current inputs to the plurality of interleaved switched inductance circuits 435-1, 435-2, . . . , 435-n. Design aspects of the aforementioned are application-specific, and depend upon factors such as power demand, current flow, operating environment, etc.

Each of high-voltage switches 432 is arranged between HV+ 456 and HV− 457 and between the inductor 431 and diode 434, and may include a semiconductor device such as a metal oxide semiconductor field-effect transistor (MOSFET), an integrated gate bipolar transistor (IGBT), or another solid state electronic switching device, and is controllable by the respective one of the gate drivers 433-1, 433-2, . . . , 433-n in a conducting mode (ON) and a blocking mode (OFF) in response to a control signal that originates from the DC-DC power converter controller 440. The capacitor 458 is arranged between HV+ 456 and HV− 457.

The electric power transfer system 400 includes a plurality of sensors that dynamically monitor and communicate parameters thereof. This includes the plurality of first current sensors 451-1, 451-2, . . . , 451-n, a second current sensor 452, and a third current sensor 453, thus providing feedback control and feed-forward control in a closed-loop operation. The second current sensor 452 is arranged to monitor a second current in the HV+ 456 of the system power bus 450B between the multi-phase interleaved switching DC-DC power converter 430 and the capacitor 458. The second current sensor 452 monitors and detects, in high fidelity, a power ripple in the output power on HV+ 456 of the system power bus 450B upstream of the capacitor 458. The third current sensor 453 is arranged to monitor a third current in HV+ 456 of the system power bus 450B between the capacitor 458 and the DC electric power system 420.

One or more of the first current sensor 451, the second current sensor 452, and the third current sensor 453 is a high bandwidth current sensor that is capable of precise, accurate measurement of current and current variations that are caused by operations of the switched inductance circuit 435.

The DC-DC power converter controller 440 includes algorithmic code, calibrations, etc., to monitor the parametric setpoint 416 for the power source bus 450A, the plurality of first currents using input from the plurality of first current sensors 451-1, 451-2, . . . , 451-n, the second current using input from the second current sensor 452, and the third current using input from the third current sensor 453.

The DC-DC power converter controller 440 also an active filter 470, which utilizes feedback from the plurality of first current sensors 451-1, 451-2, . . . , 451-n, a plurality of frequency range-specific band-pass filters 442-1, 442-2, . . . , 442-n, frequency range-specific summing blocks 460, and the plurality of gate drivers 433-1, 433-2, . . . , 433-n.

The active filter 470 is configured as follows. A first difference element 441 dynamically determines frequency range-specific amplitude differences between the third current and the second current. The frequency range-specific amplitude differences between the third current and the second current are subjected to the plurality of frequency range-specific band-pass filters 442-1, 442-2, . . . , 442-n, which simultaneously pass and attenuate portions over a plurality of specific frequency ranges that are identified by the plurality of frequency range-specific band-pass filters 442-1, 442-2, . . . , 442-n. Each element is subjected to a frequency-assigned compensation term to increase or decrease the frequency range-specific amplitude differences between the third current and the second current, and is input to the frequency range-specific summing blocks 460. The current inputs from the plurality of current sensors 451-1, 451-2, . . . , 451-n are also input to specific ones of the plurality of frequency range-specific summing blocks 460. The DC-DC power converter controller 440 controls the plurality of high-voltage switches 432 of the multi-phase interleaved switching DC-DC power converter 430 via the plurality of gate drivers 433-1, 433-2, . . . , 433-n based thereon.

The system controller 415 is arranged to monitor operating parameters of the electric power source 410, and determine a parametric setpoint 416 for the power source bus 450A based thereon. The parametric setpoint 416 may include a voltage potential, a current level, an electric power level, or another electric parameter. The system controller 415 controls electric power output of the electric power source 410 in response to the parametric setpoint 416.

The system controller 415 acts to control the electric power output of the electric power source 410 in response to the parametric setpoint 416 in concert with the DC-DC power converter controller 440 controlling the high-voltage switch 432 of the multi-phase interleaved switching DC-DC power converter 430 based upon the parametric setpoint 416, the first current, and a difference between the second current and the third current. This control action transfers the power ripple in the output power on HV+ 456 of the system power bus 450B that occurs upstream of the capacitor 458 and is caused by the operation of the multi-phase interleaved switching DC-DC power converter 430 to the electric power source 410.

The concepts described herein facilitate simultaneous operation of the DC electric power source and the switching DC-DC power converter to deliver electric power and cancel high frequency ripple current on the electric power bus where it connects to the DC electric power system.

Such an arrangement may assist system optimization by utilizing the DC electric power source, e.g., a fuel cell system. for filtering and temporary energy storage. Furthermore, the concepts described herein enable reduced filtering and energy storage requirements for electrical systems with large inherent capacitance and power delivery through a switching DC-DC power converter.

The concepts described herein employ the switching DC-DC power converter to reduce ripple on an electrical bus by actively injecting an anti-phase ripple current sourced from the electric power source while delivering dc power from the electric power source to the electric bus.

In one embodiment, the switching DC-DC power converter reduces ripple on the power source bus by actively injecting an anti-phase ripple current sourced from the electric power source employing open loop control to produce the anti-phase ripple current.

In one embodiment, the switching DC-DC power converter reduces ripple on the power source bus by actively injecting an anti-phase ripple current sourced from the electric power source employing open loop control to produce the anti-phase ripple current using detailed analysis of the electrical circuit and inputs such as component age or known static characteristics.

In one embodiment, the switching DC-DC power converter reduces ripple on the power source bus by actively injecting an anti-phase ripple current sourced from the electric power source employing open loop control to produce the anti-phase ripple current, including using the feedforward control based on the electric bus operation.

In one embodiment, the switching DC-DC power converter reduces ripple on the power source bus by actively injecting an anti-phase ripple current sourced from the electric power source employing open loop control and a dedicated phase of a multi-phase converter to provide the waveform, where this dedicated phase is optimized for this function to produce the anti-phase ripple current.

In one embodiment, the switching DC-DC power converter reduces ripple on the power source bus by actively injecting an anti-phase ripple current sourced from the electric power source employing open loop control and multiple dedicated phases, each dedicated phase is optimized for a frequency content of the ripple current to produce the anti-phase ripple current.

In one embodiment, the switching DC-DC power converter reduces ripple on the power source bus by actively injecting an anti-phase ripple current sourced from the electric power source employing open loop control and one or multiple dedicated phases, wherein each dedicated phase is optimized for a frequency content of the ripple current to produce the anti-phase ripple current.

In one embodiment, the switching DC-DC power converter reduces ripple on the power source bus by actively injecting an anti-phase ripple current sourced from the electric power source employing open loop control, closed-loop control, and multiple dedicated phases, wherein each dedicated phase is optimized for a frequency content of the ripple current to produce the anti-phase ripple current.

Benefits of employing the DC electric power source, e.g., a fuel cell system, for filtering and temporary energy storage may reduce size, weight, and cost of the system by reducing or eliminating the need for additional filtering components such as capacitors on the output bus. system level optimization and efficiency improvements may be achieved by eliminating losses associated with large, bulky capacitors that may otherwise be used in the applications. This in turn, increases power density of the application HV system. The elimination of filtering capacitors also reduces the system start up time through reduction pre-charge energy needs, control complexity, and need for pre-charge circuit hardware. The reduced energy storage requirements may also reduce or eliminate a need for special discharge circuits. These system benefits become more relevant for large scale power systems having multiple fuel cell systems and their dedicated switching DC-DC power converters supplying large loads.

Embodiments may be described herein in terms of functional and/or logical block components and various processing steps. It should be appreciated that such block components may be realized by any number, combination or collection of mechanical and electrical hardware, software, and/or firmware components configured to perform the specified functions. For example, an embodiment may employ various combinations of mechanical components and electrical components, integrated circuit components, memory elements, digital signal processing elements, logic elements, look-up tables, or the like, which may carry out a variety of functions under the control of one or more microprocessors or other control devices. Embodiments may be practiced in conjunction with any number of mechanical and/or electronic systems, and that the vehicle systems described herein are merely examples of possible implementations.

The term “controller” and related terms such as control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. Communication between controllers, and communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter may be a discrete value (e.g., either “1” or “0”), a percentage (e.g., 0% to 100%), or an infinitely variable value.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A system for transferring DC electric power to a DC electric power system, the system comprising:
an electric power source, a power source bus, a switching DC-DC power converter, a system power bus, and a controller; and
wherein the system power bus is arranged to transfer electric power between the switching DC-DC power converter and the DC electric power system;
wherein the controller is operative to:
determine a voltage ripple in the system power bus,
determine an anti-phase ripple current for the power source bus responsive to the voltage ripple in the system power bus, and
control the switching DC-DC power converter to inject the anti-phase ripple current into the system power bus,
wherein the anti-phase ripple current is sourced from the electric power source.

2. The system of claim 1, further comprising the controller being operative to employ a system model to determine the voltage ripple in the system power bus; wherein the controller is operative to control the switching DC-DC power converter in an open loop operation to inject the anti-phase ripple current into the system power bus responsive to the voltage ripple in the system power bus that is determined by the system model.

3. The system of claim 1, further comprising a sensor arranged to monitor voltage ripple in the system power bus that is input to the DC-DC power converter, wherein the controller is operative to control the switching DC-DC power converter in a closed loop operation to inject the anti-phase ripple current into the system power bus responsive to the voltage ripple in the system power bus that is input to the switching DC-DC power converter.

4. The system of claim 3, wherein the controller is operative to employ feedback control to control the switching DC-DC power converter to inject the anti-phase ripple current into the system power bus.

5. The system of claim 1, wherein the controller is operative to control the switching DC-DC power converter employing feedback control and feed-forward control to inject the anti-phase ripple current into the system power bus.

6. The system of claim 1, wherein the switching DC-DC power converter comprises a switched inductance circuit including an inductor and a high-voltage switch.

7. The system of claim 1, wherein the electric power source comprises a non-rechargeable electric power source.

8. The system of claim 7, wherein the non-rechargeable electric power source comprises one of a fuel cell stack or a photovoltaic panel.

9. The system of claim 1, wherein the electric power source comprises one of an ultracapacitor or an electrochemical battery.

10. The system of claim 1, further comprising a second DC-DC power converter;
wherein the controller is operative to:
control the switching DC-DC power converter to inject the anti-phase ripple current into the system power bus,
determine one of a voltage setpoint or a current setpoint for the DC electric power system, and
control the second DC-DC power converter based upon the voltage setpoint or the current setpoint for the DC electric power system.

11. A system for transferring DC electric power to a DC electric power system, the system comprising:
an electric power source, a power source bus, a switching DC-DC power converter, a system power bus, a first current sensor, a second current sensor, a third current sensor, a capacitor, and a controller;
wherein the first current sensor is arranged to monitor a first current in the power source bus between the electric power source and the switching DC-DC power converter;
wherein the second current sensor is arranged to monitor a second current in the system power bus between the switching DC-DC power converter and the capacitor;
wherein the third current sensor is arranged to monitor a third current in the system power bus between the capacitor and the DC electric power system;
wherein the controller is operative to:
determine a parametric setpoint for the system power bus, wherein the parametric setpoint includes a current setpoint having an anti-phase ripple current,
determine the first current, the second current, and the third current in the system power bus, and
control the switching DC-DC power converter to draw a desired current from the electric power source, wherein the desired current is based upon the current setpoint including the anti-phase ripple current, the first current, the second current, and the third current.

12. The system of claim 11, wherein the switching DC-DC power converter comprises a multi-phase interleaved DC-DC power converter including a plurality of switched inductance circuits arranged in parallel, wherein each of the plurality of switched inductance circuits includes an inductor, a high-voltage switch, and a diode; and wherein the controller is operative to control the high-voltage switch of each of the plurality of switched inductance circuits based upon the parametric setpoint, the first current, the second current, and the third current.

13. The system of claim 12, further comprising a feedback control system including a plurality of frequency range-specific band-pass filters;
wherein the controller is operative to:
determine a difference between the third current and the second current;
subject the difference between the third current and the second current to the plurality of frequency range-specific band-pass filters of the feedback control system to determine a plurality of control parameters; and
control the plurality of switched inductance circuits of the switching DC-DC power converter based upon the parametric setpoint, the first current, and the plurality of control parameters.

14. An electric power transfer system for transferring electric power between a non-rechargeable electric power source and a DC electrical system, the system comprising:
a switching DC-DC power converter, a power source bus, a system power bus including a temporary energy storage element, and a controller;
the controller being operative to:
determine a parametric setpoint for the system power bus, wherein the parametric setpoint includes a current setpoint having an anti-phase ripple current,
determine a first current in the system power bus between the electric power source and the switching DC-DC power converter,
determine a second current in the system power bus between the switching DC-DC power converter and the temporary energy storage element,
determine a third current in the system power bus between the temporary energy storage element and the DC electrical system,
determine a difference between the third current and the second current, and
control the switching DC-DC power converter based upon the parametric setpoint, the first current, and the difference between the third current and the second current.

15. The electric power transfer system of claim 14, wherein the switching DC-DC power converter comprises a DC-DC power converter including a single switched inductance circuit;
wherein the switched inductance circuit includes an inductor, a high-voltage switch, and a diode; and
wherein the controller is operative to control the high-voltage switch based upon the parametric setpoint and the difference between the second current and the third current.

16. The electric power transfer system of claim 14, wherein the switching DC-DC power converter comprises a multi-phase interleaved DC-DC power converter including a plurality of switched inductance circuits arranged in parallel, wherein each of the plurality of switched inductance circuits includes an inductor, a high-voltage switch, and a diode; and wherein the controller is operative to control the high-voltage switch of each of the plurality of switched inductance circuits based upon the parametric setpoint, the first current, the second current, and the third current.

17. The electric power transfer system of claim 16, further comprising a feedback control system including a plurality of frequency range-specific band-pass filters;
wherein the controller is operative to:
subject the difference between the third current and the second current to the plurality of frequency range-specific band-pass filters of the feedback control system to determine a plurality of control parameters; and
control the plurality of switched inductance circuits of the switching DC-DC power converter based upon the parametric setpoint, the first current, and the plurality of control parameters.

18. The electric power transfer system of claim 14, wherein the temporary energy storage element comprises a capacitor that is electrically connected between a positive link of the system power bus and a negative link of the system power bus.

19. The electric power transfer system of claim 14, wherein the non-rechargeable electric power source comprises a fuel cell.

20. The electric power transfer system of claim 14, wherein the controller is operative to control the DC-DC power converter employing feedback control and feed-forward control to inject the anti-phase ripple current into the system power bus.
